(19) United States
(12) Patent Application Publication
(10) Pub. No.: US 2026/0153057 A1
(43) Pub. Date: Jun. 4, 2026

(54) METHOD FOR PRODUCING A THROTTLE GEAR FOR A THROTTLE DEVICE

(71) Applicant: AISAN KOGYO KABUSHIKI KAISHA, Obu-shi (JP)

(72) Inventors: Toshihide KOKUBU, Obu-shi (JP); Yuichi KIMURA, Kariya-shi (JP)

(73) Assignee: AISAN KOGYO KABUSHIKI KAISHA, Obu-shi (JP)

(21) Appl. No.: 19/381,016

(22) Filed: Nov. 6, 2025

(30) Foreign Application Priority Data
Dec. 4, 2024 (JP) 2024-211122

(51) Int. Cl. F02D 9/10

(52) U.S. Cl. CPC F02D 9/1065; F02D 9/107; F02D 9/108

(57) ABSTRACT

A method for producing a throttle gear for a throttle device. The throttle device has a spring that biases the throttle gear toward a default position. The throttle gear has a spring hooking portion that makes contact with the spring when the throttle valve opens beyond the default position. The method comprises the steps of forming the throttle gear using a resin molding, and forming a contact surface of the spring hooking portion by machining a molded surface of the spring hooking portion.

### CROSS-REFERENCE TO RELATED APPLICATION

This application claims priority to Japanese patent application serial number 2024-211122 filed Dec. 4, 2024, which is hereby incorporated herein by reference in its entirety for all purposes.

### TECHNICAL FIELD

The present disclosure relates to a method for producing a throttle gear for a throttle device.

### BACKGROUND

An automotive throttle device regulates the amount of intake air supplied to an engine. It typically uses an electronic motor to rotate a shaft connected to a throttle valve, which opens and closes an intake passage. In many cases, such a throttle device has a mechanism that rotates the throttle valve to a specified default position. Therefore, even when power to the motor is cut off, a certain amount of air intake can be ensured. For example, in many conventional throttle devices, a torsion spring attached to a throttle gear is used to bias the throttle valve toward the default position. This spring has an intermediate hook that engages both the throttle body and the throttle gear to define the default position.

Traditionally, adjusting the relationship between the fully closed and the default positions involved a secondary process where a stopper's contact surface was machined while a subassembly of the throttle gear and spring was held in a jig. The jig is capable of supporting the throttle gear and spring subassembly in a state that is essentially the same as when it is assembled to the throttle body. In the above method, the stopper is secondary processed with the throttle gear and spring are assembled. However, this conventional method has a drawback that the accuracy of the adjustment can be reduced after the components are assembled into the throttle body due to variations in the spring's middle hook position and posture. Reproducibility was sometimes reduced when assembled into the throttle body after processing. To counteract this, it is necessary that the throttle gear is assembled to the throttle body when setting it in the jig, or to process the specified dimensions based on a virtual position that takes into account the state in which the throttle gear is assembled to the throttle body, which is cumbersome. Therefore, a method that can accurately adjust the relationship between the fully closed position and the default position without being affected by spring variations is desired.

### SUMMARY

One aspect of the present disclosure is a method for producing a throttle gear for a throttle device. The throttle device has a spring that biases the throttle gear toward a default position. The throttle gear has a spring hooking portion that comes into contact with the spring when the throttle valve opens beyond the default position. The method comprising the steps of: forming the throttle gear by resin molding; and then forming a contact surface of the spring hooking portion by cutting a molded surface of the spring hooking portion. This allows the relationship between the fully closed position and the default position to be adjusted before assembling the throttle gear to the spring or the throttle body. Therefore, the relationship between the fully closed position and the default position can be adjusted with high precision without being affected by spring variations. In addition, the straightness of the contact surface is higher than that of the molded surface before machining. This stabilizes the mounting position of the spring and improves the reproducibility of the default position of the throttle valve.

### BRIEF DESCRIPTION OF DRAWINGS

FIG. 1 is a perspective view of a throttle device according to an embodiment.

FIG. 2 is a vertical cross-sectional view of the throttle device of FIG. 1 taken along line II-II in FIG. 1, as seen in the direction of the axis of an intake passage.

FIG. 3 is a vertical cross-sectional view of the throttle device of FIG. 1 taken along line III-III in FIG. 1, as seen in the direction perpendicular to the axis of the intake passage.

FIG. 4 is a side view of the throttle device of FIG. 1.

FIG. 5 is an exploded perspective view of a throttle gear and a spring of the throttle device of FIG. 1.

FIG. 6 is a perspective view of the throttle gear, the spring, and the stopper of the throttle body when the throttle valve is in the default position.

FIG. 7 is a plan view of the throttle gear, the spring, and the stopper of the throttle body when the throttle valve is in the default position.

FIG. 8 is a perspective view of the throttle gear, the spring, and the stopper on the throttle body when the throttle valve is in the fully closed position.

FIG. 9 is a plan view of the throttle gear, the spring, and the stopper on the throttle body when the throttle valve is in the fully closed position.

FIG. 10 is a side view of the throttle gear showing only the gear-side spring receiving portion in cross-section, having a contact surface formed by cutting.

### DETAILED DESCRIPTION

Embodiments will now be described with reference to the drawings.

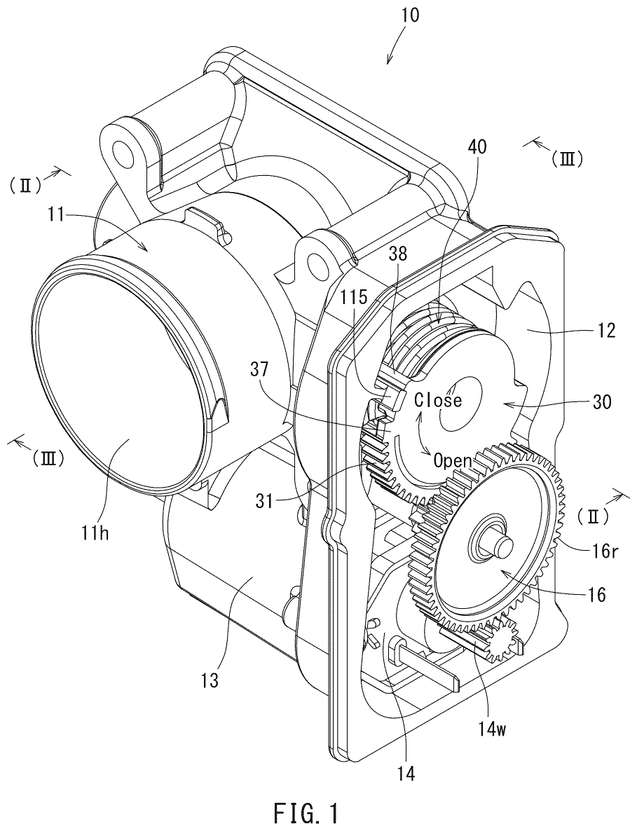

FIGS. 1 to 4 show a throttle device according to an embodiment. The throttle device is installed in a vehicle such as an automobile and regulates the amount of air intake into an engine. The throttle device has a throttle body 10. The throttle body 10 has a throttle pipe portion 11 that forms a substantially cylindrical intake passage (bore) 11h that constitutes a part of an intake passage to the engine.

A rotatable disc-shaped throttle valve 20 is disposed within the intake passage 11h of the throttle body 10 to regulate the flow rate that passes through the intake passage 11h. The throttle valve 20 is supported so that it can rotate between a fully closed position and a fully open position within the intake passage 11h. The throttle body 10 has a throttle shaft 21 extending across the intake passage 11h. The throttle shaft 21 is secured in a non-rotatable state relative to the rotational center of the throttle valve 20. The throttle shaft 21 is rotatably supported on both sides of the intake passage 11h by bearings 11r and 11j mounted on the throttle body 10.

The throttle device has a motor 14 as a drive source for driving the throttle valve 20. The rotation output generated by the motor 14 is transmitted to the throttle shaft 21 via a transmission mechanism. In one embodiment, the transmission mechanism comprises a drive gear 14w fixed to an output shaft of the motor 14, an intermediate gear 16 rotatably supported on the throttle body 10 via an intermediate shaft, and a throttle gear 30, which is a driven gear fixed coaxially to the throttle shaft 21. The motor 14 and the transmission mechanism are accommodated in a motor housing portion 13 and a gear housing portion 12, respectively, which are integrally formed with the throttle pipe portion 11 of the throttle body 10. The gear housing portion 12 and the motor housing portion 13 are closed by a cover (not shown). The intermediate gear 16 has a large-diameter gear teeth 16r and a small-diameter gear teeth 16s. The large-diameter gear teeth 16r mesh with the drive gear 14w, and the small-diameter gear teeth 16s mesh with a gear teeth 31 of the throttle gear 30. By controlling the rotation direction and rotation amount of the motor 14, the opening degree of the throttle valve 20 is adjusted.

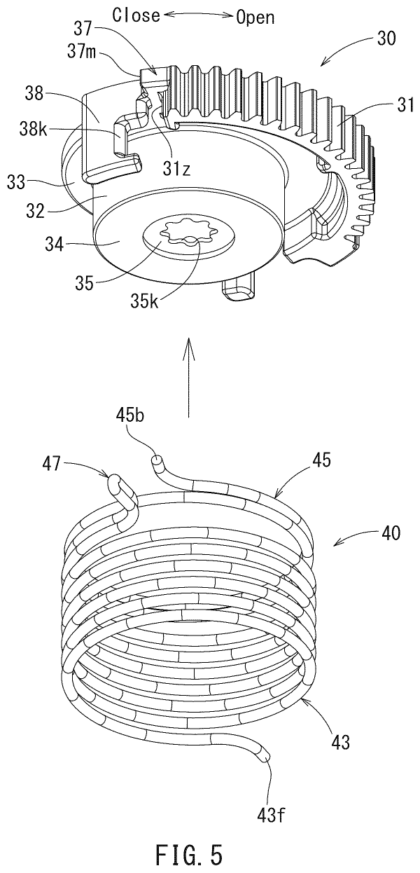

The throttle gear 30 is, for example, made of resin. The resin may be a fiber-reinforced resin containing fibers such as glass fibers. As shown in FIG. 5, the throttle gear 30 has, for example, a cylindrical portion 32 and an outward flange 33 extending outward from the end of the cylindrical portion 32. The gear teeth 31 of the throttle gear 30 are arranged on a portion of the outer circumference of the outward flange 33.

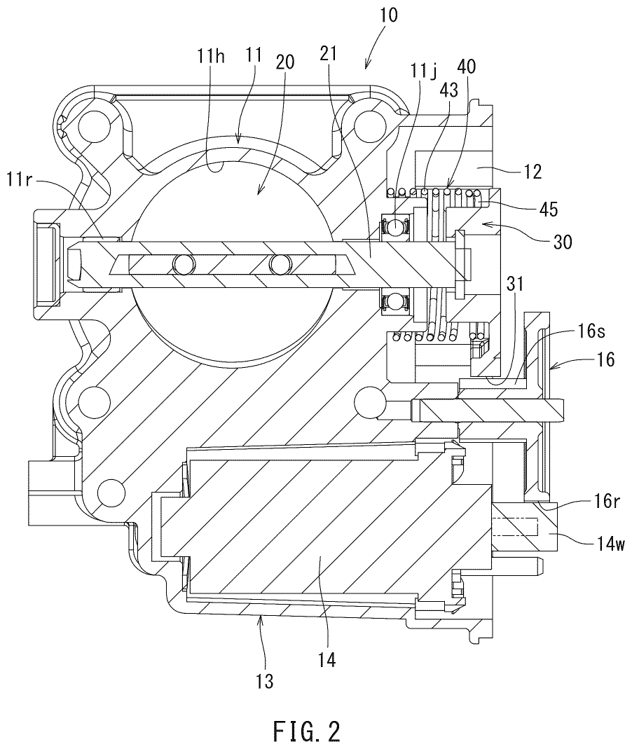

As shown in FIG. 2, the throttle gear 30 is attached to the end of the throttle shaft 21, which protrudes into the gear housing portion 12 of the throttle body 10, in a manner that prevents relative rotation. The throttle gear 30 has a connecting plate 35 fixed to the cylindrical portion 32 (e.g., an inward flange 34). The connecting plate 35 may be fixed, for example, by embedding its outer peripheral portion into the cylindrical portion 32 of the throttle gear 30 by insert molding. The connecting plate 35 has a through hole 35k. The end of the throttle shaft 21 is inserted into the through hole 35k of the connecting plate 35 and fixed by an appropriate method such as crimping, screwing, or welding. The throttle shaft 21 and the throttle gear 30 are held so as not to rotate relative to each other.

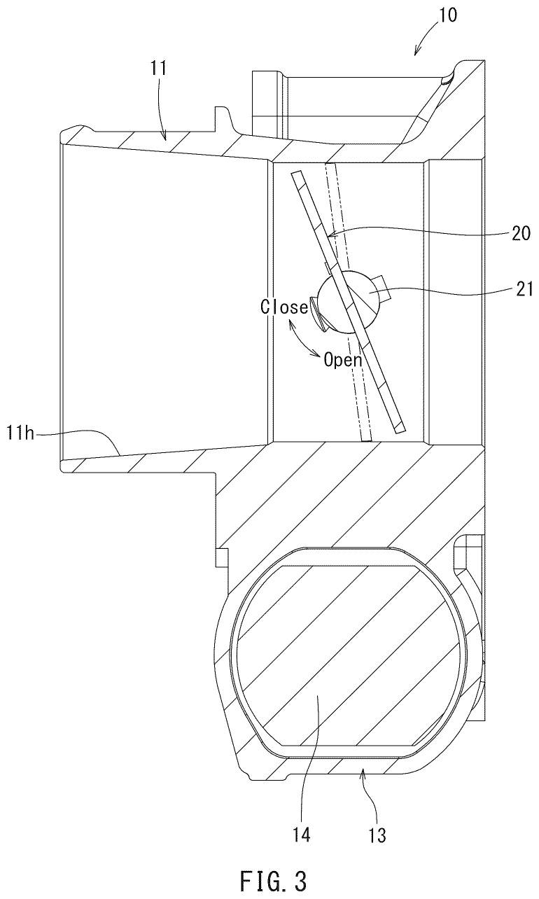

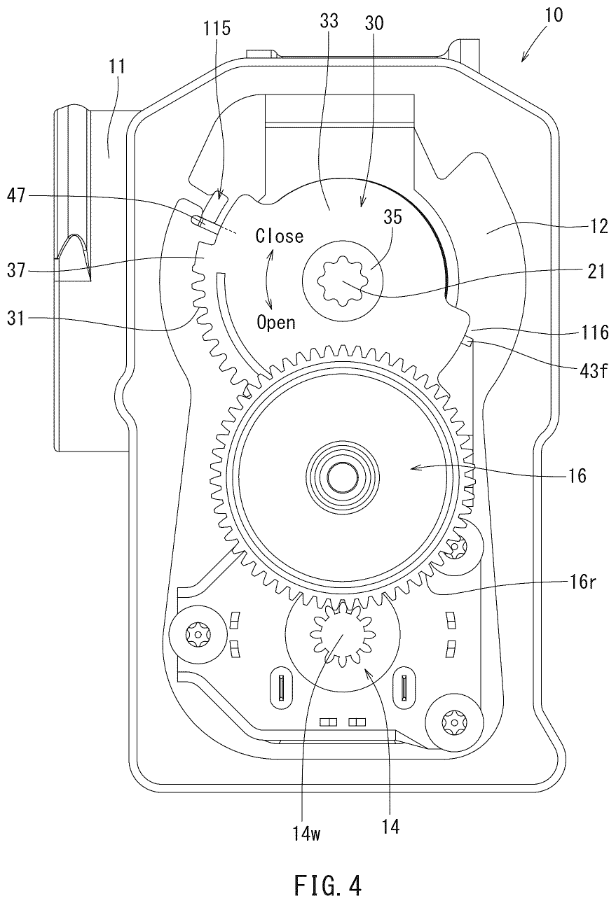

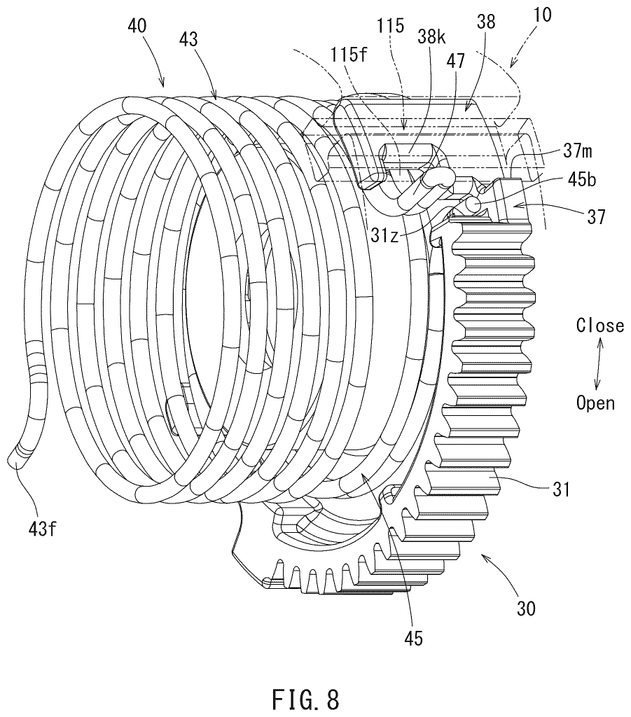

As shown in FIGS. 4 and 5, the throttle gear 30 has a fully closed position stopper 37 that can come into contact with a stopper 115 provided on the throttle body 10. The contact between a contact surface 37m of the fully closed position stopper 37 of the throttle gear 30 and a contact surface 115f of the stopper 115 of the throttle body 10 defines the fully closed position (indicated by the two-dot line in FIG. 3 and FIG. 8) of the throttle valve 20.

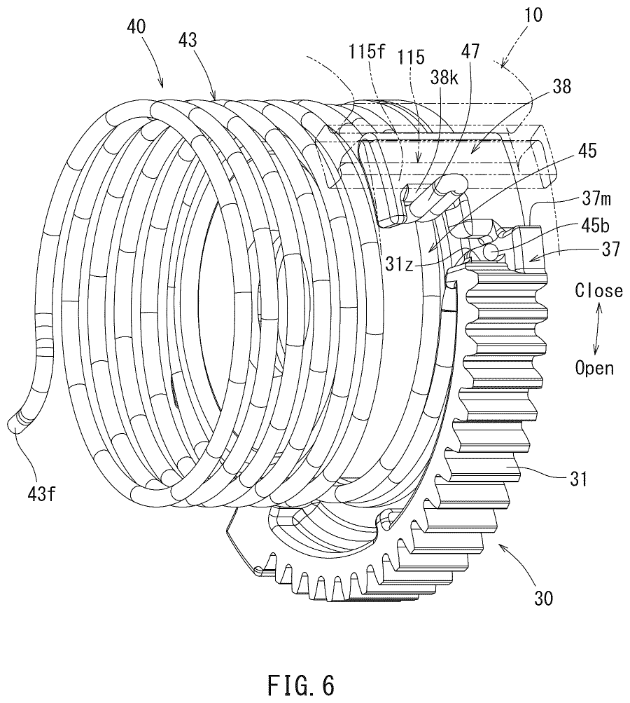

As shown in FIGS. 5 to 9, the throttle device has a torsion spring 40 that biases the throttle valve 20 toward the default position (solid line in FIG. 3 and FIG. 6). The default position is a predetermined position slightly open from the fully closed position. When power is supplied to the motor 14, the throttle valve 20 can be rotated to any position between the fully closed position and the fully open position against the biasing force of the spring 40. When power to the motor 14 is cut off, the throttle valve 20 is automatically rotated to the default position by the biasing force of spring 40. Therefore, a small amount of air can be supplied to the engine through the intake passage 11h.

The spring 40 is composed of a return spring portion 43 and an opener spring portion 45, which are wound in opposite directions and connected in series. The spring 40 is interposed between the throttle body 10 and the throttle gear 30 (i.e., around the cylindrical portion 32 of throttle gear 30) (see FIG. 2). Both terminal ends 43f and 45b of the spring 40 are bent to protrude radially outward. The terminal end 43f is hooked to a spring hooking portion 116 (see FIG. 4) provided on the throttle body 10. The terminal end 45b is hooked to a spring hooking portion 31z provided on the throttle gear 30.

The connection portion between the return spring portion 43 and the opener spring portion 45 is formed as a U-shaped folded portion. The folded portion is bent so that it protrudes radially outward. The bent fold serves as an intermediate hook 47, hooked to at least one of the contact surface 38k of a gear-side spring receiving portion 38 provided on the throttle gear 30 and the contact surface 115f of the stopper (a body-side spring receiving portion) 115 provided on the throttle body 10 (see FIG. 4). The gear-side spring receiving portion 38 may be formed to protrude in the same direction as the cylindrical portion 32, for example, from the outward flange 33 of the throttle gear 30 near the spring hooking portion 31z.

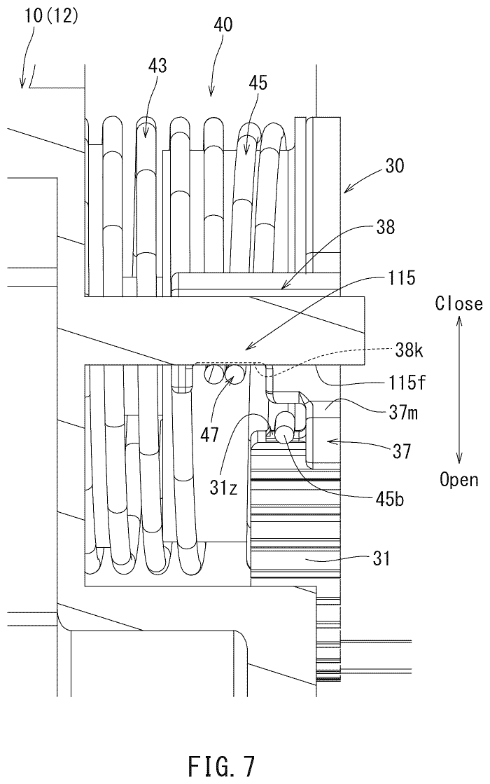

When the throttle gear 30 is in the default position (FIGS. 6 and 7), the intermediate hook 47 is hooked to both the gear-side spring receiving portion 38 provided on the throttle gear 30 and the stopper 115 provided on the throttle body 10. At this time, both the return spring portion 43 and the opener spring portion 45 are twisted in the direction of contraction from their natural state and are in a state of preload (a state of stored elastic energy).

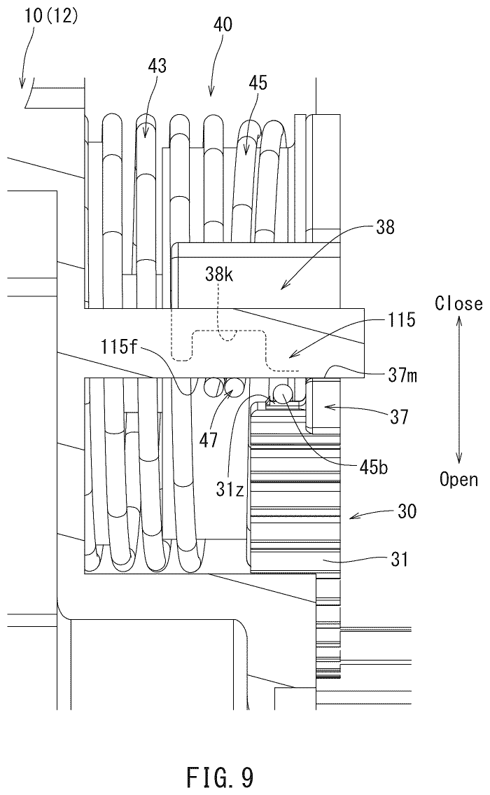

When the throttle gear 30 attempts to rotate from the default position toward the fully closed position (FIGS. 8 and 9) due to the drive of the motor 14, the intermediate hook 47 of the spring 40 hooked to the stopper 115 provided on the throttle body 10. Therefore, the return spring portion 43, whose both terminal ends are constrained by the throttle body 10, is rendered ineffective. Meanwhile, the throttle gear 30 rotates relative to the throttle body 10 while the intermediate hook 47 remains hooked to the stopper 115 on the body side. Therefore, the gear-side spring receiving portion 38 of the throttle gear 30 moves away from the intermediate hook 47. The throttle gear 30 rotates while holding the terminal end 45b of the spring 40. Therefore, the opener spring portion 45 twists further in the direction of reduced diameter. When the throttle gear 30 is in the fully closed position relative to the default position and power to the motor 14 is cut off, the throttle gear 30 is returned to the default position by the biasing force of the opener spring portion 45.

When the throttle gear 30 attempts to rotate from the default position toward the fully open position due to the drive of the motor 14, the intermediate hook 47 remains hooked to the gear-side spring receiving portion 38 of the throttle gear 30. Therefore, the opener spring portion 45, whose both terminal ends are constrained by the throttle gear 30, is rendered ineffective. Meanwhile, the throttle gear 30 rotates relative to the throttle body 10 while keeping the intermediate hook 47 hooked to the gear-side spring receiving portion 38. Therefore, the return spring portion 43 twists further in the direction of reduced diameter. When the throttle gear 30 is in the fully open position relative to the default position and power to the motor 14 is cut off, the throttle gear 30 is returned to the default position by the biasing force of the return spring portion 43.

As shown in FIGS. 6 to 9, the contact surface 115f of the stopper 115 of the throttle body 10 may be formed such that the portion where the intermediate hook 47 of the spring 40 contacts (the body-side spring receiving portion) and the portion where the fully closed position stopper 37 of the throttle gear 30 contacts (the body-side fully closed stopper) are on the same plane. However, in another embodiment not shown, the two portions of the contact surface 115f may be formed on different planes or may be provided at entirely different positions in the throttle body 10.

In another embodiment not shown in the figure, the return spring and the opener spring may be formed as separate springs rather than as part of a single continuous spring 40 (i.e., the return spring portion 43 and the opener spring portion 45) as described above. In this case, the portion corresponding to the intermediate hook 47 may be provided on a connecting member that connects the return spring portion 43 and the opener spring portion 45.

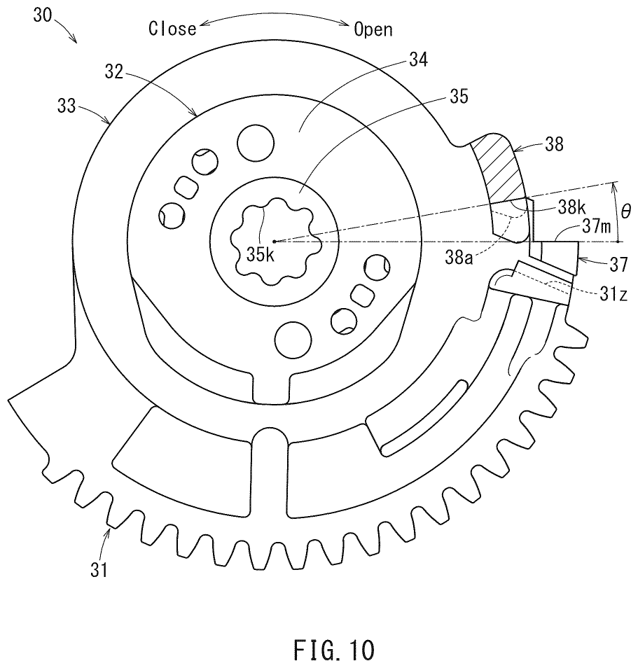

As shown in FIG. 10, the contact surface 38k of the gear-side spring receiving portion 38 provided on the throttle gear 30 is formed after the throttle gear 30 is resin-molded but before it is assembled to the throttle body 10. This is done by machining a forming surface 38a of the gear-side spring receiving portion 38 using a cutting tool. The contact surface 38k is created at a position corresponding to a predetermined angle θ relative to the default opening angle, as measured from the contact surface 37m of the fully closed position stopper 37 of the throttle gear 30. This machining method allows for precise adjustment of the relationship between the fully closed and the default positions before the throttle gear 30 is assembled with the spring 40 or the throttle body 10. This high-precision adjustment isn't affected by variations in the spring. Machining the surface also improves the straightness of the contact surface 38k, which is higher than that of the original forming surface 38a. This increases straightness stabilizes the mounting of the spring 40 and improves the reproducibility of the default position of the throttle valve 20. Furthermore, if the throttle gear 30 is made of a fiber-containing resin (like glass fiber), the cross-section of the glass fiber formed by machining is exposed on the contact surface 38k. This makes it possible to confirm whether machining has been performed by examining the surface condition of the machined portion of the throttle gear 30.

The spring 40 is assembled onto the throttle gear 30, and the subassembly of the throttle gear 30 and spring 40 is set into the throttle body 10. At this stage, the throttle gear 30 and throttle shaft 21 are still capable of relative rotation. Next, with the fully closed position stopper 37 of the throttle gear 30 in contact with the contact surface 115f of the stopper 115 of the throttle body 10, the throttle valve 20 fixed to the throttle shaft 21 is held in the fully closed position. This determines the relative positional relationship between the throttle gear 30 and the throttle valve 20 (the throttle shaft 21). Then, while maintaining this positional relationship, the throttle shaft 21 and throttle gear 30 are fixed in a manner that prevents relative rotation using the aforementioned crimping or other means.

In another embodiment, the throttle gear has a gear-side fully closed position stopper that contacts the body-side fully closed position stopper provided on the throttle body of the throttle device when the throttle valve is in the fully closed position. The formation of the contact surface of the spring receiving portion by the aforementioned machining is performed with the contact surface of the gear-side fully closed position stopper as a reference. This enables the appropriate relationship between the fully closed position and the default position of the throttle valve to be accurately realized.

In another embodiment, the throttle gear machining is made of glass fiber-containing resin. The cross section of the glass fiber formed by the machining is exposed on the contact surface of the spring receiving portion. This makes it possible to confirm whether the machining has been performed by examining the surface condition of the machined portion of the throttle gear.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved method for producing a throttle gear for a throttle device.

What is claimed is:

1. A method for producing a throttle gear for a throttle device having a spring that biases the throttle gear toward a default position, the method comprising the steps of:
using resin molding to form the throttle gear, wherein the throttle gear has a spring hooking portion configured to contact the spring when a throttle valve opens beyond the default position; and
machining a molded surface of the spring hooking portion to form a contact surface of the spring hooking portion.

2. The method of claim 1, further comprises a step of forming a contact surface of a spring receiving portion by machining with a contact surface of a gear-side fully closed position stopper as a reference, wherein the gear-side fully closed position stopper is configured to contact a body-side fully closed position stopper located on a throttle body of the throttle device when the throttle valve is in the fully closed position.

3. The method of claim 1, wherein the throttle gear is made of glass fiber-containing resin, further comprises a step of forming an exposed cross section of the glass fiber on the contact surface of the spring receiving portion by machining.
